(19) United States
(12) Patent Application Publication
(10) Pub. No.: US 2025/0054109 A1
(43) Pub. Date: Feb. 13, 2025

(54) DATA TRANSMISSION METHOD, APPARATUS AND SYSTEM, DEVICE AND STORAGE MEDIUM

(71) Applicant: GRAVITYXR ELECTRONICS AND TECHNOLOGY CO., LTD., Zhejiang (CN)

(72) Inventors: Jinfeng ZHAN, Zhejiang (CN); Rui ZHANG, Zhejiang (CN); Tao JIA, Zhejiang (CN); Chaohao WANG, Zhejiang (CN)

(73) Assignee: GRAVITYXR ELECTRONICS AND TECHNOLOGY CO., LTD., Zhejiang (CN)

(21) Appl. No.: 18/929,660

(22) Filed: Oct. 29, 2024

Related U.S. Application Data
(63) Continuation of application No. PCT/CN2023/106505, filed on Jul. 10, 2023.

(30) Foreign Application Priority Data
Aug. 15, 2022 (CN) 202210977328.3

(51) Int. Cl. G06T 5/50; G06T 1/20

(52) U.S. Cl. CPC G06T 5/50; G06T 1/20; G06T 2207/20221

(57) ABSTRACT

A data transmission method includes: acquiring data of a display image layer and data of a transparency layer and determining, based on the data of the display image layer and the data of the transparency layer, multiple sets of data to be superimposed; constructing a target layer based on the display image layer and the transparency layer for each set of data to be superimposed; determining first placement data and second placement data of the corresponding target layer based on the data of the display image layer and the data of the transparency layer for each set of data to be superimposed; placing the first placement data to a first position of the corresponding target layer and placing the second placement data to a second position of the corresponding target layer, to obtain data of the corresponding target layer; and transmitting data of multiple target layers.

### CROSS-REFERENCE TO RELATED APPLICATIONS

This application is a continuation of International Application No. PCT/CN2023/106505, filed on Jul. 10, 2023, which claims priority to Chinese Patent Application No. 202210977328.3, filed on Aug. 15, 2022 and entitled “Data Transmission Method, Apparatus and System, Device and Storage Medium”. The disclosures of the aforementioned applications are hereby incorporated by reference in their entireties.

### TECHNICAL FIELD

The present application relates to the field of chip technology and, in particular, to a data transmission method, apparatus and system, a device and a storage medium.

### BACKGROUND

At present, when it is necessary to transmit layer transparency information or data of a transparency layer between chips, it is mainly through peripheral component interconnect express (PCIe) or a universal serial bus (USB) to set a channel separately to transmit the data of the transparency layer; or in addition to data of a corresponding display image layer, a mobile industry processor interface (MIPI) or a Display Port interface signal is separately set for transmission.

Therefore, the above methods need to respectively deploy additional hardware interfaces on the chips at both ends for data transmission, resulting in large power loss.

### SUMMARY

The present application aims to solve at least one of technical problems in the related art to a certain extent. Therefore, one purpose of the present application is to propose a data transmission method, apparatus and system, a device and a storage medium.

In order to solve the above technical problem, embodiments of the present application provide the following technical solutions.

A data transmission method may include: acquiring data of a display image layer and data of a transparency layer and determining, based on the data of the display image layer and the data of the transparency layer, multiple sets of data to be superimposed; constructing a target layer based on the display image layer and the transparency layer for each set of data to be superimposed; determining first placement data and second placement data of the corresponding target layer based on the data of the display image layer and the data of the transparency layer for each set of data to be superimposed; placing the first placement data to a first position of the corresponding target layer and placing the second placement data to a second position of the corresponding target layer, to obtain data of the corresponding target layer; and transmitting data of multiple target layers.

In an implementation, the acquiring the data of the display image layer and the data of the transparency layer and the determining, based on the data of the display image layer and the data of the transparency layer, the multiple sets of data to be superimposed may include: acquiring both a first matching parameter of the data of the display image layer and a second matching parameter of the data of the transparency layer; comparing the first matching parameter with the second matching parameter; and if the first matching parameter is consistent with the second matching parameter, acquiring the data of the display image layer corresponding to the first matching parameter and the data of the transparency layer matching the second matching parameter, and determining the data of the display image layer and the data of the transparency layer as the data to be superimposed.

In an implementation, the constructing the target layer based on the display image layer and the transparency layer for each set of data to be superimposed may include: acquiring a first parameter of the display image layer for each set of data to be superimposed; acquiring a second parameter of the transparency layer for each set of data to be superimposed; obtaining a construction parameter based on the first parameter and the second parameter for the data to be superimposed; and constructing the target layer based on the construction parameter.

In an implementation, the determining the first placement data and the second placement data of the corresponding target layer based on the data of the display image layer and the data of the transparency layer for each set of data to be superimposed may include: determining the data of the display image layer as the first placement data, and determining the data of the transparency layer as the second placement data; placing the data of the display image layer to the first position, and placing the data of the transparency layer to the second position; where the second position is determined according to the first position.

In an implementation, the determining the first placement data and the second placement data of the corresponding target layer based on the data of the display image layer and the data of the transparency layer for each set of data to be superimposed may include: determining the data of the transparency layer as the first placement data, and determining the data of the display image layer as the second placement data; placing the data of the transparency layer to the first position, and placing the data of the display image layer to the second position; where the second position is determined according to the first position.

In an implementation, the transmitting the data of the multiple target layers may include: judging whether the data of each target layer needs to be compressed; if the data of the target layer needs to be compressed, determining the data of the target layer as data to be compressed, compressing the data to be compressed to obtain compressed data, and transmitting the compressed data; or if the data of the target layer does not need to be compressed, transmitting the data of the target layer directly.

In an implementation, the judging whether the data of each target layer needs to be compressed may include: acquiring a transmission parameter of the data of each target layer; comparing the transmission parameter of the data of each target layer with a threshold of the transmission parameter; if the transmission parameter is greater than the threshold of the transmission parameter, determining the data of the target layer corresponding to the transmission parameter as the data to be compressed; or, if the transmission parameter is less than or equal to the threshold of the transmission parameter, calculating actual transmission power consumption of the data of the target layer, and calculating compression transmission power consumption of the compressed data of the target layer; comparing the actual transmission power consumption with the compression transmission power consumption; if the actual transmission power consumption is greater than the compression transmission power consumption, determining the data of the target layer corresponding to the actual transmission power consumption as the data to be compressed.

An embodiment of the present application further provides a data transmission apparatus, which may include: an acquiring module, configured to acquire data of a display image layer and data of a transparency layer and determine, based on the data of the display image layer and the data of the transparency layer, multiple sets of data to be superimposed; a construction module, configured to construct a target layer based on the display image layer and the transparency layer for each set of data to be superimposed; a determining module, configured to determine first placement data and second placement data of the corresponding target layer based on the data of the display image layer and the data of the transparency layer for each set of data to be superimposed; a placing module, configured to place the first placement data to a first position of the corresponding target layer and place the second placement data to a second position of the corresponding target layer, to obtain data of the corresponding target layer; a transmission module, configured to transmit data of multiple target layers.

An embodiment of the present application further provides a data transmission system, which may include: a first chip, including a GPU, a DPU and a first interface that are connected communicatively; where the GPU is configured to acquire data of a display image layer and data of a transparency layer and determine, based on the data of the display image layer and the data of the transparency layer, multiple sets of data to be superimposed; construct a target layer based on the display image layer and the transparency layer for each set of data to be superimposed; determine first placement data and second placement data of the corresponding target layer based on the data of the display image layer and the data of the transparency layer for each set of data to be superimposed; place the first placement data to a first position of the corresponding target layer and place the second placement data to a second position of the corresponding target layer, to obtain data of each target layer; and send data of multiple target layers to the first interface based on the DPU; a second chip, configured to receive the data of the multiple target layers sent by the first chip through the first interface.

An embodiment of the present application further provides an electronic device, which may include: a processor, a memory, and a computer program stored in the memory and configured to be executed by the processor, where when the processor executes the computer program, the methods above are implemented.

An embodiment of the present application further provides a computer-readable storage medium, which may include: a stored computer program which, when running, controls a device where the computer-readable storage medium is located to execute the methods above.

The embodiments of the present application have the following technical effects:
the above technical solution of the present application can establish a data transmission channel based on the network, the first interface of the first chip and the second interface of the second chip, and through the data transmission channel, simultaneous transmission of the data of the corresponding display image layer and the data of the transparency layer can be achieved, without having to provide an interface for establishing a second data transmission channel, which saves hardware resources. In addition, the data of the corresponding display image layer and the data of the transparency layer are transmitted simultaneously based on the same data transmission channel, which realizes the synchronization of the data of the display image layer and the data of the transparency layer, and solves the problem of asynchronous transmission of data.

Some of additional aspects and advantages of the present application will be given in the following description, and some will become apparent from the following description, or be learned from the practice of the present application.

### BRIEF DESCRIPTION OF DRAWINGS

In combination with the drawings, other features, purposes and advantages of the present application will become more apparent through the following detailed description of non-limiting embodiments.

FIG. 1 is a schematic structural diagram of a data transmission system provided by an embodiment of the present application.

FIG. 2 is a flowchart of a data transmission method provided by an embodiment of the present application.

FIG. 3 is a first schematic structural diagram of a target layer provided by an embodiment of the present application.

FIG. 4 is a second schematic structural diagram of a target layer provided by an embodiment of the present application.

FIG. 5 is a third schematic structural diagram of a target layer provided by an embodiment of the present application.

FIG. 6 is a fourth schematic structural diagram of a target layer provided by an embodiment of the present application.

FIG. 7 is a schematic structural diagram of a data transmission apparatus provided by an embodiment of the present application.

### DESCRIPTION OF EMBODIMENTS

In order to better understand the present application, each aspect of the present application will be described in more detail with reference to the drawings. It should be understood that these detailed descriptions are only descriptions of the exemplary implementations of the present application, rather than limiting the scope of the present application in any way. In the full text of the specification, same reference numbers refer to same elements. Expression “and/or” includes any and all combinations of one or more of associated listed items.

It should be noted that, in the specification, expressions such as first, second, and third are only used to distinguish one feature from another, and do not represent any restrictions on the feature.

It should also be understood that terms “including”, “comprising”, “having”, “covering” and/or “containing”, when used in the specification, indicate the existence of the stated features, elements and/or components, but do not exclude the existence or addition of one or more other features, elements, components and/or their combinations. In addition, when a statement such as “at least one of . . . ” appears after a list of listed features, it modifies an entire listed feature rather than individual elements in the list. In addition, when describing implementations of the present application, “may” is used to indicate “one or more implementations of the present application”. Moreover, a term “exemplary” is intended to refer to an example or illustration.

Unless otherwise defined, all terms used herein (including technical terms and scientific terms) have the same meanings as those commonly understood by those of ordinary skill in the art to which the present application belongs. It should also be understood that terms (such as those defined in commonly used dictionaries) should be interpreted as having meanings consistent with their meanings in the context of relevant technologies, and will not be interpreted in an idealized or overly formal way, unless explicitly defined herein.

It should be noted that, in the case of no conflict, embodiments in the present application and features in the embodiments can be combined with each other. The present application will be described in detail below with reference to the drawings and in combination with the embodiments.

The features, principles and other aspects of the present application are described in detail below.

In order to facilitate the understanding of the embodiments by those skilled in the art, some terms are explained.

1) GPU: Graphics Processing Unit.

2) DPU: Display Processing Unit.

3) SoC: System on Chip.

4) DRAM: Dynamic Random Access Memory.

5) DSC: Display Stream Compression.

At present, if data of a transparency layer is not subject to special processing, when the data of the transparency layer is transmitted, a data stream related to the data of the transparency layer exists individually and is stored separately from data of a display image layer, and is subsequently read separately. Therefore, when the data of the transparency layer is transmitted, it is also necessary to set a separate channel to transmit only the data of the transparency layer, which will lead to the problem of an independent data stream, high complexity for implementation, and difficulty in synchronizing the data of the display image layer and the data of the transparency layer.

In order to solve the above problem, embodiments of the present application provide the following technical solution.

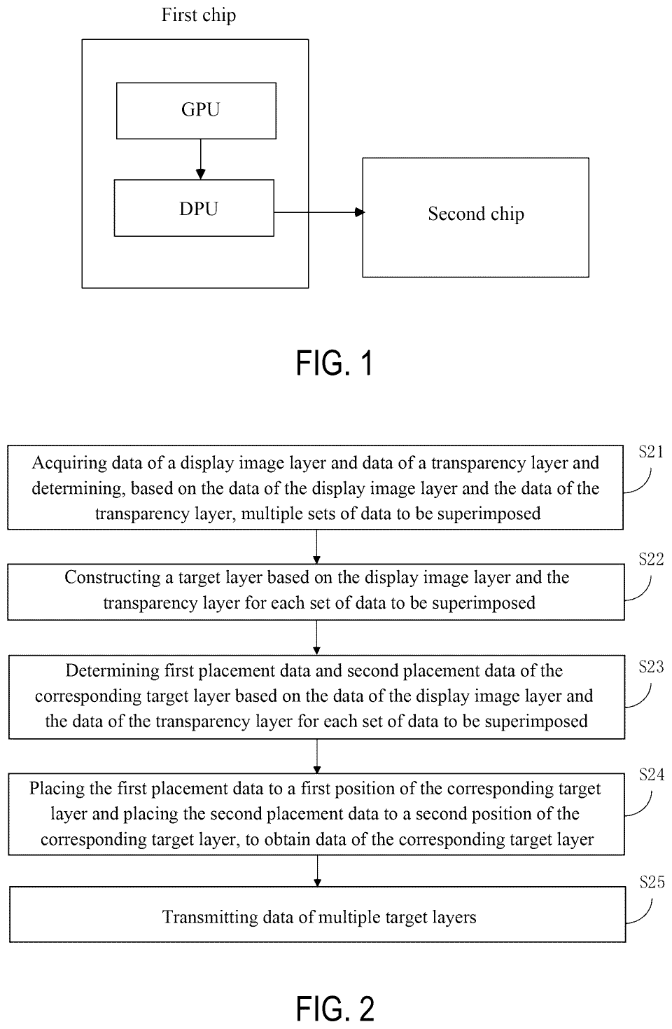

As shown in FIG. 1, an embodiment of the present application also provides a data transmission system, which includes:
a first chip, including a GPU, a DPU and a first interface that are connected in communicatively; where the GPU is configured to acquire data of a display image layer and data of a transparency layer and determine, based on the data of the display image layer and the data of the transparency layer, multiple sets of data to be superimposed; construct a target layer based on the display image layer and the transparency layer for each set of data to be superimposed;
determine first placement data and second placement data of the corresponding target layer based on the data of the display image layer and the data of the transparency layer for each set of data to be superimposed; place the first placement data to a first position of the corresponding target layer and place the second placement data to a second position of the corresponding target layer, to obtain data of the corresponding target layer; and send data of multiple target layers to the first interface based on the DPU;
where the first interface of the present application can be implemented based on a USB, a PCIe and other interfaces;
a second chip, configured to receive the data of the multiple target layers sent by the first chip through the first interface.

In the embodiment of the present application, correspondingly, the second chip is provided with a second interface for receiving the data of the target layer sent by the first chip through the first interface.

The second interface of the present application can also be implemented based on a USB, a PCIe and other interfaces.

The second chip can be implemented based on the SoC.

In the embodiment of the present application, a transmission parameter of the data of the target layer is determined through the DPU; where the transmission parameter can be calculated based on resolution, data frame rate and other parameters.

After obtaining the transmission parameter of the data of the target layer, the transmission parameter is compared with a transmission parameter threshold. If the transmission parameter is greater than the transmission parameter threshold, it indicates that the bandwidth of the current data channel cannot support the transmission of the data of the target layer. Therefore, the DPU will compress the data of the target layer to obtain the compressed data, and send the compressed data to the first interface; where the transmission parameter threshold is set according to an adaptive bandwidth of the first interface, for transmitting data from the DPU based on the first interface.

If the transmission parameter is less than or equal to the threshold of the transmission parameter, it indicates that the bandwidth of the current data channel can support the transmission of the data of the target layer, then actual transmission power consumption of the data of the target layer is calculated, and compression transmission power consumption of the compressed data of the target layer is calculated. If the actual transmission power consumption is greater than the compression transmission power consumption, the DPU compresses the data of the target layer. If the actual transmission power consumption is less than the compression transmission power consumption, the DPU will not compress the data of the target layer, but directly send the data of the target layer to the first interface.

In addition, the DPU is a display processing unit, which usually performs local/global color calibration, local/global dynamic range enhancement, image enhancement processing related to display characteristics (such as display brightness uniformity compensation, etc.), image data compression and other operations on the data of the display image layer in a form of pipeline, which can effectively improve the final display effect on the display side, and is necessary for the data of the actual image layer. In the embodiment of the present application, after the data of the transparency layer is also added to the target layer, it is transmitted simultaneously with the data of the display image layer. The above mentioned DPU display processing unit can be reused, and the data of the transparency layer can also be processed to some extent, such as compression.

In the embodiment of the present application, based on the network, the first interface of the first chip and the second interface of the second chip, a data transmission channel can be established, and through this data transmission channel, the data of the corresponding display image layer and the data of the transparency layer can be simultaneously transmitted, without having to provide an interface for establishing a second data transmission channel, which saves hardware resources. In addition, the data of the corresponding display image layer and the data of the transparency layer are transmitted simultaneously based on the same data transmission channel, which realizes the synchronization of the data of the display image layer and the data of the transparency layer, and solves a problem of asynchronous transmission of data.

As shown in FIG. 2, the embodiment of the present application provides a data transmission method applied to the data transmission system shown in FIG. 1, which includes the following.

Step S21: acquiring data of a display image layer and data of a transparency layer and determining, based on the data of the display image layer and the data of the transparency layer, multiple sets of data to be superimposed.

In the embodiment of the present application, the data of the display image layer and the data of the transparency layer will be read out from system cache or the DRAM simultaneously.

Specifically, the acquiring the data of the display image layer and the data of the transparency layer and the determining, based on the data of the display image layer and the data of the transparency layer, the multiple sets of data to be superimposed include:
acquiring both a first matching parameter of the data of the display image layer and a second matching parameter of the data of the transparency layer;
comparing the first matching parameter with the second matching parameter;
if the first matching parameter is consistent with the second matching parameter, acquiring the data of the display image layer corresponding to the first matching parameter and the data of the transparency layer matching the second matching parameter, and determining the data of the display image layer and the data of the transparency layer as the data to be superimposed.

In the embodiment of the present application, when reading data from the DRAM, a set of data is read at a time, which includes the data of the display image layer and the data of the transparency layer, each set of data is processed based on subsequent algorithms, and the above steps are repeated to read multiple sets of data of the display image layer and data of the transparency layer and then multiple sets of data to be superimposed are obtained.

When determining the same set of data, the data of the display image layer and the data of the transparency layer that need to be read at the same time can be determined according to a matching parameter. For example, if the matching parameter is a timestamp, the first matching parameter is the timestamp of the data of the display image layer; and the second matching parameter is the timestamp of the data of the transparency layer;

The data of the display image layer and the data of the transparency layer with the same timestamp are read; or other matching parameters are set according to actual needs, to read the data of the display image layer and data of the transparency layer for the same set.

Step S22: constructing a target layer based on the display image layer and the transparency layer for each set of data to be superimposed.

Specifically, the constructing the target layer based on the display image layer and the transparency layer for each set of data to be superimposed includes:
acquiring a first parameter of the display image layer for each set of data to be superimposed;
acquiring a second parameter of the transparency layer for each set of data to be superimposed;
obtaining a construction parameter based on the first parameter and the second parameter for the data to be superimposed;
constructing the target layer based on the construction parameter.

In the embodiment of the present application, after the data of the display image layer and data of the transparency layer for one set are read at the same time, the first parameter of the display image layer is acquired; where the first parameter is a size of the display image layer, for example, a length and a width of the display image layer and other parameters used to represent the size; and the second parameter of the transparency layer is acquired; where the second parameter is a size of the transparency layer.

According to the size of the display image layer and the size of the transparency layer, based on an existing algorithm which is not limited in detail by the embodiment of the present application, the construction parameter of the target layer is calculated, that is, the size of the target layer, and the target layer is constructed according to the size of the target layer.

The size of the target layer of the present application is larger than the size of the display image layer, and the size of the target layer is equal to a sum of the size of the display image layer and the size of the transparency layer.

In the embodiment of the present application, the parameters of the target layer are acquired based on the size of the display image layer and the size of the transparency layer. The size of the display image layer is expanded based on the size of the transparency layer on the basis of the size of the display image layer, which is used to realize the simultaneous transmission of the data of the corresponding display image layer and the size of the transparency layer based on the target layer.

Step S23: determining first placement data and second placement data of the corresponding target layer based on the data of the display image layer and the data of the transparency layer for each set of data to be superimposed.

Step S24: placing the first placement data to a first position of the corresponding target layer and placing the second placement data to a second position of the corresponding target layer, to obtain data of the corresponding target layer.

In an embodiment of the present application, the determining the first placement data and the second placement data of the corresponding target layer based on the data of the display image layer and the data of the transparency layer for each set of data to be superimposed includes:
determining the data of the display image layer as the first placement data, and determining the data of the transparency layer as the second placement data;
placing the data of the display image layer to the first position, and placing the data of the transparency layer to the second position;
where the second position is determined according to the first position.

In the embodiment of the present application, according to actual needs, the data of the display image layer determined as the first placement data can be placed to the first position of the target layer, the remaining position of the target layer can be determined as the second position, and then the data of the transparency layer determined as the second placement data can be placed to the second position of the target layer.

After an area corresponding to the first position is determined, the second position may be located at the top, bottom and either side of the first position.

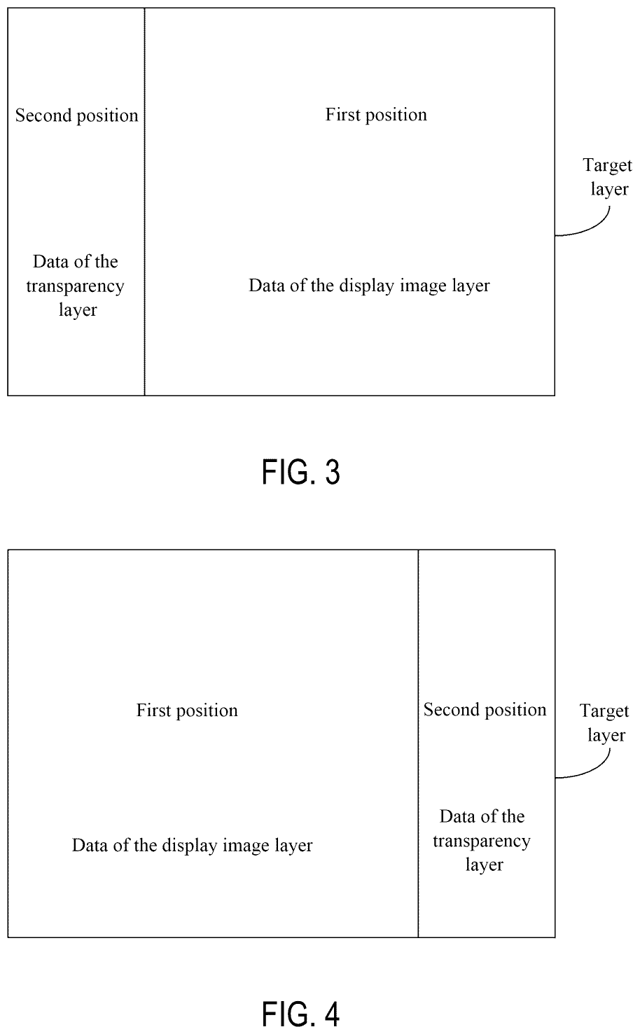

As shown in FIG. 3, the data of the display image layer determined as the first placement data can be placed to the first position of the target layer according to actual needs, the remaining position of the target layer is determined as the second position, and then the data of the transparency layer determined as the second placement data is placed to the second position of the target layer; where the second position is on the left side of the first position.

As shown in FIG. 4, the data of the display image layer determined as the first placement data can be placed to the first position of the target layer according to actual needs, the remaining position of the target layer is determined as the second position, and then the data of the transparency layer determined as the second placement data is placed to the second position of the target layer; where the second position is on the right side of the first position.

In an embodiment of the present application, the determining the first placement data and the second placement data of the corresponding target layer based on the data of the display image layer and the data of the transparency layer for each set of data to be superimposed includes:
determining the data of the transparency layer as the first placement data, and determining the data of the display image layer as the second placement data;
placing the data of the transparency layer to the first position, and placing the data of the display image layer to the second position;
where the second position is determined according to the first position.

In the embodiment of the present application, according to the actual needs, the data of the transparency layer determined as the first placement data can be placed to the first position of the target layer, the remaining position of the target layer is determined as the second position, and then the data of the display image layer determined as the second placement data is placed to the second position of the target layer.

After the area corresponding to the first position is determined, the second position may be located at the top, bottom and either side of the first position.

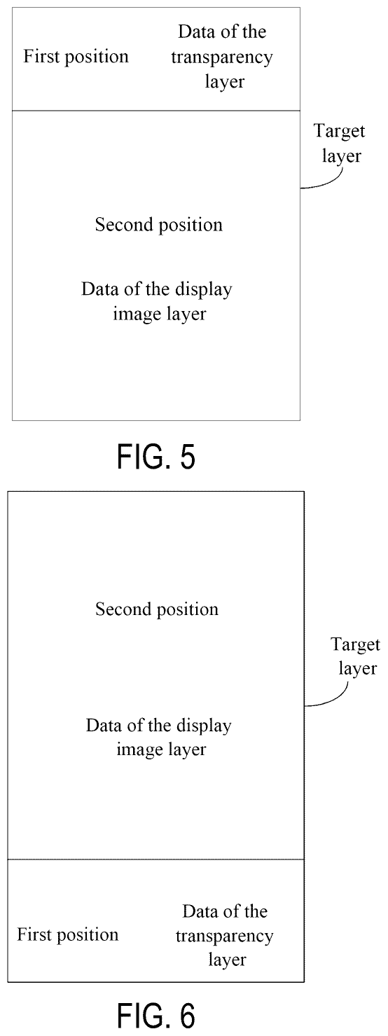

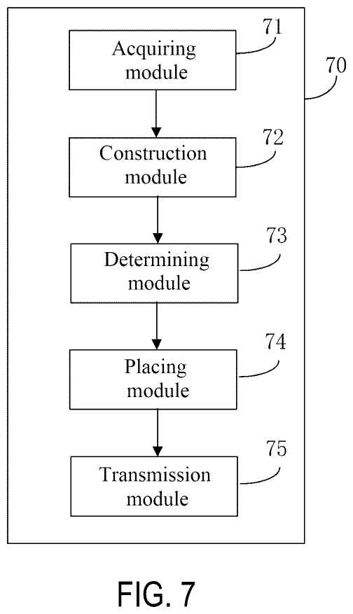

As shown in FIG. 5, in the embodiment of the present application, the data of the transparency layer determined as the first placement data can be placed to the first position of the target layer according to the actual needs, the remaining position of the target layer is determined as the second position, and then the data of the display image layer determined as the second placement data is placed to the second position of the target layer; where the second position is located at the bottom of the first position.

As shown in FIG. 6, in the embodiment of the present application, according to the actual needs, the data of the transparency layer determined as the first placement data can be placed to the first position of the target layer, the remaining position of the target layer is determined as the second position, and then the data of the display image layer determined as the second placement data is placed to the second position of the target layer; where the second position is located at the top of the first position.

Step S25: transmitting data of multiple target layers.

Specifically, the transmitting data of the multiple target layers includes:
judging whether the data of each target layer needs to be compressed;
if the data of the target layer needs to be compressed, determining the data of the target layer as data to be compressed, compressing the data to be compressed to obtain compressed data, and transmitting the compressed data; or
if the data of the target layer does not need to be compressed, transmitting the data of the target layer directly.

Further, the judging whether the data of each target layer needs to be compressed includes:
acquiring a transmission parameter of the data of each target layer;
comparing the transmission parameter of the data of each target layer with a threshold of the transmission parameter;
if the transmission parameter is greater than the threshold of the transmission parameter, determining the data of the target layer corresponding to the transmission parameter as the data to be compressed;
or, if the transmission parameter is less than or equal to the threshold of the transmission parameter, calculating actual transmission power consumption of the data of the target layer, and calculating compression transmission power consumption of the compressed data of the target layer; comparing the actual transmission power consumption with the compression transmission power consumption; if the actual transmission power consumption is greater than the compression transmission power consumption, determining the data of the target layer corresponding to the actual transmission power consumption as the data to be compressed.

In an embodiment of the present application, a resolution and a frame rate of the data of the target layer are acquired, and the data of the transmission target layer is calculated based on the resolution and the frame rate of the data of the target layer, the actual bandwidth required, that is, the transmission parameter, the actual bandwidth obtained by calculation is compared with a bandwidth threshold. If the actual bandwidth is greater than the bandwidth threshold, it means that the current bandwidth cannot support the transmission of the data of the target layer. Therefore, the data of the target layer needs to be compressed. During compression, the data of the display image layer and the data of the transparency layer need to be compressed. For magnification of the compression, it is preset according to actual needs. After the compression of the data of the target layer is completed, the compressed data is obtained and the compressed data is transmitted.

For example, if the data of the display image layer has an 8 bit depth with a resolution of 4000*2000 and the frame rate is 120 fps, the actual bandwidth required to transmit the data of the display image layer without compression is 23 Gbps. If the data of the transparency layer with the same bit depth plus the same resolution, the actual bandwidth required to transmit the data of the target layer will be larger, for example, 46 Gbps.

If the bandwidth threshold is 30 Gbps, then 30 Gbps<46 Gbps, indicating that the bandwidth of the current data channel cannot support the transmission of the data of the target layer, therefore, the data of the target layer needs to be compressed.

Generally, magnification of lossless compression can be less than ½. After the size of the data of the target layer is compressed to ½ of the original size, the actual bandwidth required for transmitting compressed data is 23 Gbps, 23 Gbps<30 Gbps, therefore, compressed data after compression can be transmitted over the current data channel.

Further, in an embodiment of the present application, the data of the target layer can be compressed based on the compression algorithm of the image compression technology; for example, the data of the target layer can be compressed based on a DSC compression algorithm of an MIPI interface or a display port interface.

In the embodiment of the present application, after acquiring the actual bandwidth required for data transmission of each target layer, the actual bandwidth corresponding to the data of each target layer is compared with the bandwidth threshold. If the actual bandwidth is greater than the bandwidth threshold, the data of the target layer is compressed to obtain compressed data, and the compressed data is transmitted, which realizes the transmission and compression of the matched data of the display image layer and data of the transparency layer at the same time. The operation is simple and easy to achieve. At the same time, the bandwidth required for data transmission is saved, and the transmission rate and efficiency are improved.

In an embodiment of the present application, if the transmission parameter is less than or equal to the threshold of the transmission parameter, actual transmission power consumption of the data of the target layer is calculated, and compression transmission power consumption of the compressed data of the target layer is calculated.

For example, if the data of the display image layer has an 8 bit depth with a resolution of 4000*2000 and the frame rate is 120 fps, the actual bandwidth required to transmit the data of the display image layer without compression is 23 Gbps. If the data of the transparency layer with the same bit depth plus the same resolution, the actual bandwidth required to transmit the data of the target layer will be larger, for example, 46 Gbps.

If the bandwidth threshold is 50 Gbps, then 50 Gbps>46 Gbps, indicating that the current data channel bandwidth can support the data transmission of the target layer.

Then the actual transmission power consumption of the data of the target layer is calculated, and the compression transmission power consumption of the compressed data of the target layer is calculated.

Assuming that the actual transmission power consumption is M and the compression transmission power consumption is N, if M>N, the data of the target layer needs to be compressed; or M<N, the data of the target layer does not need to be compressed and the data of the target layer can be directly transmitted based on the current data channel.

In the embodiment of the present application, when the actual bandwidth is less than or equal to the bandwidth threshold, the actual transmission power consumption of the data of the target layer is calculated, and the compression transmission power consumption of the compressed data of the target layer is calculated. If the actual transmission power consumption is greater than the compression transmission power consumption, the data of the target layer is compressed to obtain compressed data, and the compressed data is transmitted, thereby further saving the bandwidth required for data transmission, and improving the transmission rate and efficiency.

An embodiment of the present application also provides a data transmission apparatus 70, including:
an acquiring module 71, configured to acquire data of a display image layer and data of a transparency layer and determine, based on the data of the display image layer and the data of the transparency layer, multiple sets of data to be superimposed;
a construction module 72, configured to construct a target layer based on the display image layer and the transparency layer for each set of data to be superimposed;
a determining module 73, configured to determine first placement data and second placement data of the corresponding target layer based on the data of the display image layer and the data of the transparency layer for each set of data to be superimposed;
a placing module 74, configured to place the first placement data to a first position of the corresponding target layer and place the second placement data to a second position of the corresponding target layer, to obtain data of the corresponding target layer; and
a transmission module 75, configured to transmit data of multiple target layers.

In an implementation, the acquiring the data of the display image layer and the data of the transparency layer and the determining, based on the data of the display image layer and the data of the transparency layer, the data to be superimposed include:
acquiring both a first matching parameter of the data of the display image layer and a second matching parameter of the data of the transparency layer;
comparing the first matching parameter with the second matching parameter;
if the first matching parameter is consistent with the second matching parameter, acquiring the data of the display image layer corresponding to the first matching parameter and the data of the transparency layer matching the second matching parameter, and determining the data of the display image layer and the data of the transparency layer as the data to be superimposed.

In an implementation, the constructing the target layer based on the display image layer and the transparency layer for each set of data to be superimposed includes:
acquiring a first parameter of the display image layer for each set of data to be superimposed;
acquiring a second parameter of the transparency layer for each set of data to be superimposed;
obtaining a construction parameter based on the first parameter and the second parameter for the data to be superimposed; and
constructing the target layer based on the construction parameter.

In an implementation, the determining the first placement data and the second placement data of the corresponding target layer based on the data of the display image layer and the data of the transparency layer for each set of data to be superimposed includes:
determining the data of the display image layer as the first placement data, and determining the data of the transparency layer as the second placement data; and
placing the data of the display image layer to the first position, and placing the data of the transparency layer to the second position;
where the second position is determined according to the first position.

In an implementation, the determining the first placement data and the second placement data of the corresponding target layer based on the data of the display image layer and the data of the transparency layer for each set of data to be superimposed includes:
determining the data of the transparency layer as the first placement data, and determining the data of the display image layer as the second placement data;
placing the data of the transparency layer to the first position, and placing the data of the display image layer to the second position;
where the second position is determined according to the first position.

In an implementation, the transmitting the data of the multiple target layers includes:
judging whether the data of each target layer needs to be compressed;
if the data of the target layer needs to be compressed, determining the data of the target layer as data to be compressed, compressing the data to be compressed to obtain compressed data, and transmitting the compressed data; or
if the data of the target layer does not need to be compressed, transmitting the data of the target layer directly.

In an implementation, the judging whether the data of each target layer needs to be compressed includes:
acquiring a transmission parameter of the data of each target layer;
comparing the transmission parameter of the data of each target layer with a threshold of the transmission parameter;
if the transmission parameter is greater than the threshold of the transmission parameter, determining the data of the target layer corresponding to the transmission parameter as the data to be compressed;
or, if the transmission parameter is less than or equal to the threshold of the transmission parameter, calculating actual transmission power consumption of the data of the target layer, and calculating compression transmission power consumption of the compressed data of the target layer; comparing the actual transmission power consumption with the compression transmission power consumption; if the actual transmission power consumption is greater than the compression transmission power consumption, determining the data of the target layer corresponding to the actual transmission power consumption as the data to be compressed.

An embodiment of the present application also provides an electronic device, including a processor, a memory, and a computer program stored in the memory and configured to be executed by the processor, where when the processor executes the computer program, the method described above is implemented.

An embodiment of the present application also provides a computer-readable storage medium, where the computer-readable storage medium includes a stored computer program which, when running, controls a device where the computer-readable storage medium is located to execute the method described above.

In addition, other configurations and functions of the apparatuses in the embodiments of the present application are known to those skilled in the art, for the sake of redundancy, they will not be repeated here.

It should be noted that logic and/or steps represented in the flowcharts or described in other ways here, for example, can be considered as an ordered list of executable instructions for realizing logic functions, and can be specifically implemented in any computer-readable medium for use by instruction execution systems, apparatuses or devices (such as computer-based systems, systems including processors, or other systems that can extract and execute instructions from the instruction execution systems, the apparatuses, or the devices), or in combination with these instruction execution systems, the apparatuses, or the devices. For the specification, “computer-readable medium” can be any apparatus that can include, store, communicate, broadcast or transmit programs for use by or in combination with the instruction execution systems, the apparatuses, or the devices. More specific examples of the computer-readable medium (a non-exhaustive list) include the following: an electrical connection part (an electronic apparatus) with one or more wiring, a portable computer disk box (a magnetic apparatus), a random access memory (RAM), a read-only memory (ROM), an erasable and editable read-only memory (EPROM or a flash memory), an optical fiber apparatus, and a portable compact disk read-only memory (CDROM). In addition, the computer-readable medium can even be paper or other suitable medium on which the program can be printed, that is because the program can be obtained electronically, for example, by performing optical scanning, then editing, interpreting, or processing in other suitable ways when necessary on the paper or other medium, and then storing the obtained program in a computer memory.

It should be understood that each part of the present application may be implemented in hardware, software, firmware or a combination thereof. In the above implementation, multiple steps or methods can be implemented with software or firmware stored in the memory and executed by a suitable instruction execution system. For example, if it is implemented by hardware, as in another implementation, it can be implemented by any one of the following technologies or their combinations known in the art: a discrete logic circuit with a logic gate circuit for realizing a logic function on a data signal, a special integrated circuit with a suitable combined logic gate circuit, a programmable gate array (PGA), a field programmable gate array (FPGA), etc.

The above description is only a preferred embodiment of the present application and an explanation of the applied technical principle. Those skilled in the art should understand that the scope involved in the present application is not limited to the technical solution constituted by a specific combination of the above technical features, but also covers other technical solutions formed by an arbitrary combination of the above technical features or their equivalent features without departing from conception of the present application, for example, a technical solution formed by replacing the above features with technical features with similar functions disclosed (but not limited to) in the present application.

What is claimed is:

1. A data transmission method, comprising:
acquiring data of a display image layer and data of a transparency layer and determining, based on the data of the display image layer and the data of the transparency layer, multiple sets of data to be superimposed;
constructing a target layer based on the display image layer and the transparency layer for each set of data to be superimposed;
determining first placement data and second placement data of the target layer based on the data of the display image layer and the data of the transparency layer for each set of data to be superimposed;
placing the first placement data to a first position of the target layer and placing the second placement data to a second position of the target layer, to obtain data of the target layer;
transmitting data of multiple target layers.

2. The method according to claim 1, wherein the acquiring the data of the display image layer and the data of the transparency layer, and the determining, based on the data of the display image layer and the data of the transparency layer, the multiple sets of data to be superimposed comprise:
acquiring both a first matching parameter of the data of the display image layer and a second matching parameter of the data of the transparency layer;
comparing the first matching parameter with the second matching parameter;
if the first matching parameter is consistent with the second matching parameter, acquiring the data of the display image layer corresponding to the first matching parameter and the data of the transparency layer matching the second matching parameter, and determining the data of the display image layer and the data of the transparency layer as the data to be superimposed.

3. The method according to claim 1, wherein the constructing the target layer based on the display image layer and the transparency layer for each set of data to be superimposed comprises:
acquiring a first parameter of the display image layer for each set of data to be superimposed;
acquiring a second parameter of the transparency layer for each set of data to be superimposed;
obtaining a construction parameter based on the first parameter and the second parameter for the data to be superimposed;
constructing the target layer based on the construction parameter.

4. The method according to claim 1, wherein the determining the first placement data and the second placement data of the target layer based on the data of the display image layer and the data of the transparency layer for each set of data to be superimposed comprises:
determining the data of the display image layer as the first placement data, and determining the data of the transparency layer as the second placement data;
placing the data of the display image layer to the first position, and placing the data of the transparency layer to the second position;
wherein the second position is determined according to the first position.

5. The method according to claim 1, wherein the determining the first placement data and the second placement data of the target layer based on the data of the display image layer and the data of the transparency layer for each set of data to be superimposed comprises:
determining the data of the transparency layer as the first placement data, and determining the data of the display image layer as the second placement data;
placing the data of the transparency layer to the first position, and placing the data of the display image layer to the second position;
wherein the second position is determined according to the first position.

6. The method according to claim 1, wherein the transmitting the data of the multiple target layers comprises:
judging whether the data of each target layer needs to be compressed;
if the data of the target layer needs to be compressed, determining the data of the target layer as data to be compressed, compressing the data to be compressed to obtain compressed data, and transmitting the compressed data; or
if the data of the target layer does not need to be compressed, transmitting the data of the target layer directly.

7. The method according to claim 6, wherein the judging whether the data of each target layer needs to be compressed comprises:
acquiring a transmission parameter of the data of each target layer;
comparing the transmission parameter of the data of each target layer with a threshold of the transmission parameter;
if the transmission parameter is greater than the threshold of the transmission parameter, determining the data of the target layer corresponding to the transmission parameter as the data to be compressed;
or, if the transmission parameter is less than or equal to the threshold of the transmission parameter, calculating actual transmission power consumption of the data of the target layer, and calculating compression transmission power consumption of the compressed data of the target layer; comparing the actual transmission power consumption with the compression transmission power consumption; if the actual transmission power consumption is greater than the compression transmission power consumption, determining the data of the target layer corresponding to the actual transmission power consumption as the data to be compressed.

8. A data transmission apparatus, comprising:
a processor;
a communication interface connected with the processor;
a memory storing a computer program and connected with the processor;
wherein the computer program, when executed by the processor, cause the processor to:
acquire data of a display image layer and data of a transparency layer, and determine, based on the data of the display image layer and the data of the transparency layer, multiple sets of data to be superimposed;
construct a target layer based on the display image layer and the transparency layer for each set of data to be superimposed;
determine first placement data and second placement data of the target layer based on the data of the display image layer and the data of the transparency layer for each set of data to be superimposed;
place the first placement data to a first position of the target layer and place the second placement data to a second position of the target layer, to obtain data of the target layer;
transmit, through the communication interface, data of multiple target layers.

9. The apparatus according to claim 8, wherein the computer program further causes the processor to:
acquire both a first matching parameter of the data of the display image layer and a second matching parameter of the data of the transparency layer;
compare the first matching parameter with the second matching parameter;
if the first matching parameter is consistent with the second matching parameter, acquire the data of the display image layer corresponding to the first matching parameter and the data of the transparency layer matching the second matching parameter, and determine the data of the display image layer and the data of the transparency layer as the data to be superimposed.

10. The apparatus according to claim 8, wherein the computer program further causes the processor to:
acquire a first parameter of the display image layer for each set of data to be superimposed;
acquire a second parameter of the transparency layer for each set of data to be superimposed;
obtain a construction parameter based on the first parameter and the second parameter for the data to be superimposed;
construct the target layer based on the construction parameter.

11. The apparatus according to claim 8, wherein the computer program further causes the processor to:
determine the data of the display image layer as the first placement data, and determine the data of the transparency layer as the second placement data;
place the data of the display image layer to the first position, and place the data of the transparency layer to the second position;
wherein the second position is determined according to the first position.

12. The apparatus according to claim 8, wherein the computer program further causes the processor to:
determine the data of the transparency layer as the first placement data, and determine the data of the display image layer as the second placement data;
place the data of the transparency layer to the first position, and place the data of the display image layer to the second position;
wherein the second position is determined according to the first position.

13. The apparatus according to claim 8, wherein the computer program further causes the processor to:
judge whether the data of each target layer needs to be compressed;
if the data of the target layer needs to be compressed, determine the data of the target layer as data to be compressed, compress the data to be compressed to obtain compressed data, and transmit, thorough the communication interface, the compressed data; or
if the data of the target layer does not need to be compressed, transmit, thorough the communication interface, the data of the target layer directly.

14. The apparatus according to claim 8, wherein the computer program further causes the processor to:
acquire a transmission parameter of the data of each target layer;
compare the transmission parameter of the data of each target layer with a threshold of the transmission parameter;
if the transmission parameter is greater than the threshold of the transmission parameter, determine the data of the target layer corresponding to the transmission parameter as the data to be compressed;
or, if the transmission parameter is less than or equal to the threshold of the transmission parameter, calculate actual transmission power consumption of the data of the target layer, and calculate compression transmission power consumption of the compressed data of the target layer;
compare the actual transmission power consumption with the compression transmission power consumption; if the actual transmission power consumption is greater than the compression transmission power consumption, determine the data of the target layer corresponding to the actual transmission power consumption as the data to be compressed.

15. A data transmission system, comprising:
a first chip, comprising a graphics processing unit (GPU), a display processing unit (DPU) and a first interface that are connected communicatively; wherein the GPU is configured to acquire data of a display image layer and data of a transparency layer, and determine, based on the data of the display image layer and the data of the transparency layer, multiple sets of data to be superimposed; construct a target layer based on the display image layer and the transparency layer for each set of data to be superimposed; determine first placement data and second placement data of each target layer based on the data of the display image layer and the data of the transparency layer for each set of data to be superimposed; place the first placement data to a first position of the target layer and place the second placement data to a second position of the target layer, to obtain data of each target layer; and send data of multiple target layers to the first interface based on the DPU;
a second chip, configured to receive the data of the multiple target layers sent by the first chip through the first interface.

16. The system according to claim 15, wherein the GPU is further configured to:
acquire both a first matching parameter of the data of the display image layer and a second matching parameter of the data of the transparency layer;
compare the first matching parameter with the second matching parameter;
if the first matching parameter is consistent with the second matching parameter, acquire the data of the display image layer corresponding to the first matching parameter and the data of the transparency layer matching the second matching parameter, and determine the data of the display image layer and the data of the transparency layer as the data to be superimposed.

17. The system according to claim 15, wherein the GPU is further configured to:
acquire a first parameter of the display image layer for each set of data to be superimposed;
acquire a second parameter of the transparency layer for each set of data to be superimposed;
obtain a construction parameter based on the first parameter and the second parameter for the data to be superimposed;
construct the target layer based on the construction parameter.

18. The system according to claim 15, wherein the GPU is further configured to:
determine the data of the display image layer as the first placement data, and determine the data of the transparency layer as the second placement data;
place the data of the display image layer to the first position, and place the data of the transparency layer to the second position;
wherein the second position is determined according to the first position.

19. The system according to claim 15, wherein the GPU is further configured to:
determine the data of the transparency layer as the first placement data, and determine the data of the display image layer as the second placement data;
place the data of the transparency layer to the first position, and place the data of the display image layer to the second position;
wherein the second position is determined according to the first position.

20. A non-transitory computer-readable storage medium, comprising a stored computer program which, when running, controls a device in which the computer-readable storage medium is located to execute the method according to claim 1.
